(19) United States
(12) Patent Application Publication
(10) Pub. No.: US 2015/0218666 A1
(43) Pub. Date: Aug. 6, 2015

(54) BLAST FURNACE INSTALLATION

(71) Applicant: MITSUBISH HEAVY INDUSTRIES, LTD., Tokyo (JP)

(72) Inventors: Keiichi Nakagawa, Tokyo (JP); Setsuo Omoto, Tokyo (JP); Masakazu Sakaguchi, Tokyo (JP); Tsutomu Hamada, Tokyo (JP); Takeshi Okada, Tokyo (JP)

(73) Assignee: MITSUBISHI HEAVY INDUSTRIES, LTD., Tokyo (JP)

(21) Appl. No.: 14/413,872

(22) PCT Filed: Sep. 5, 2013
(86) PCT No.: PCT/JP2013/073879

§ 371 Date: Jan. 9, 2015

(30) Foreign Application Priority Data
Sep. 20, 2012 (JP) 2012-206777

(51) Int. Cl. C21B 7/00; C21B 5/00; F27B 1/26; F27B 1/16; F27B 1/20; C21B 7/16; B02C 21/00

(52) U.S. Cl. CPC C21B 7/00; C21B 7/16; C21B 5/008; C21B 5/007; C21B 5/006; C21B 5/003; B02C 21/00; F27B 1/16; F27B 1/20; F27B 1/26

(57) ABSTRACT

This blast furnace installation is configured such that when pulverized coal, which has been prepared by pulverizing high-grade coal, is pneumatically conveyed into a supply tank by a combustion gas, pulverized coal, which has been prepared by drying, dry-distilling, cooling, and pulverizing low-grade coal with a drying device, a dry-distillation device, a cooling device, and a pulverization device, is supplied from a storage tank by a feeder and pneumatically conveyed into the supply tank by a nitrogen gas, and then the pulverized coals in the supply tank are pneumatically conveyed from a supply line into an injection lance by a carrier gas, a control unit controls the feeders so as to gradually increase the supply amount of pulverized coal while maintaining the total amount of supply amount of pulverized coal and supply amount of pulverized coal to be supplied to the tuyere at a prescribed amount.

### TECHNICAL FIELD

The present invention relates to a blast furnace installation.

### BACKGROUND ART

Blast furnace installations have been configured so as to be capable of producing pig iron from iron ore by charging a starting material such as iron ore, limestone or coal from the top into the interior of the blast furnace body and blowing hot air and pulverized coal (pulverized coal injection: PCI coal) as auxiliary fuel from a tuyere disposed at a lower portion on the side of the blast furnace body.

### PRIOR ART DOCUMENTS

### Patent Documents

Patent Document 1: Japanese Unexamined Patent Application Publication No. H04-093512A

Patent Document 2: Japanese Unexamined Patent Application Publication No. H10-060508A

Patent Document 3: Japanese Unexamined Patent Application Publication No. H11-092809A

Patent Document 4: Japanese Unexamined Patent Application Publication No. 2007-239019A

### SUMMARY OF THE INVENTION

### Technical Problem

If the PCI coal blown into the blast furnace body as auxiliary fuel generates unburned carbon, there is the possibility of the unburned carbon obstructing the flow of combustion gas. Therefore, since high combustion performance is required, expensive, high-grade anthracite coal, bituminous coal or the like is used, causing an increase in the production cost of pig iron.

Accordingly, an object of the present invention is to provide a blast furnace installation that can reduce the production cost of pig iron.

### Solution to Problems

To solve the above problems, the blast furnace installation pertaining to the first invention is equipped with a blast furnace body, a starting material charging means for charging starting material from a top into an interior of the blast furnace body, a hot air blowing means for blowing hot air into the blast furnace body through a tuyere, and a pulverized coal supply means for supplying pulverized coal into the blast furnace body through the tuyere, wherein the pulverized coal supply means is equipped with a moisture removal means for high-grade coal for evaporating moisture in high-grade coal; a pulverization means for high-grade coal for pulverizing the high-grade coal, from which moisture has been removed by the moisture removal means for high-grade coal, to provide pulverized coal; a moisture removal means for low-grade coal for evaporating moisture in low-grade coal; a pyrolysis means for pyrolyzing the low-grade coal from which moisture has been removed by the moisture removal means for low-grade coal; a cooling means for cooling the low-grade coal that has been pyrolyzed by the pyrolysis means; a pulverization means for low-grade coal for pulverizing the low-grade coal that has been cooled by the cooling means, to provide pulverized coal; a supply tank of which the interior is maintained in an inert gas atmosphere, and into the interior of which are put the pulverized coal of high-grade coal and the pulverized coal of low-grade coal obtained through pulverization by the pulverization means for high-grade coal and the pulverization means for low-grade coal; a conveying means for high-grade coal for conveying the pulverized coal of high-grade coal obtained through pulverization by the pulverization means for high-grade coal into the supply tank; a supply amount adjustment means for high-grade coal for adjusting a supply amount C1 of the pulverized coal of high-grade coal to be conveyed into the supply tank; a conveying means for low-grade coal for pneumatically conveying the pulverized coal of low-grade coal obtained through pulverization by the pulverization means for low-grade coal into the supply tank by an inert gas; a supply amount adjustment means for low-grade coal for adjusting a supply amount C2 of the pulverized coal of low-grade coal to be conveyed into the supply tank; a pulverized coal pneumatic supply means for pneumatically conveying the pulverized coal in the supply tank by a carrier gas and supplying the pulverized coal to the tuyere; and a control means for controlling the supply amount adjustment means for low-grade coal and the supply amount adjustment means for high-grade coal so as to gradually increase the supply amount C2 while maintaining the total amount of the supply amount C1 and the supply amount C2 at a prescribed amount Ct.

The blast furnace installation pertaining to the second invention is a blast furnace installation in which the pulverized coal supply means is equipped with a carrier gas state detection means which detects at least one state among the temperature, oxygen concentration, carbon monoxide concentration and carbon dioxide concentration of the carrier gas near the tuyere; the pulverized coal pneumatic supply means is equipped with an air feeding means for feeding air, an air feed amount adjustment means for adjusting a feed amount G1 of air from the air feeding means, an inert gas feeding means for feeding inert gas, an inert gas feed amount adjustment means for adjusting a feed amount G2 of inert gas from the inert gas feeding means, and a supply line for supplying the pulverized coal by pneumatic conveyance to the tuyere, by the carrier gas obtained by joining the air from the air feeding means and the inert gas from the inert gas feeding means; and the control means controls the air feed amount adjustment means and the inert gas feed amount adjustment means based on information from the carrier gas state detection means so as to bring the temperature Tg of the carrier gas in a range of an upper limit value Tu to a lower limit value Td while maintaining the total amount of a feed amount G1 and feed amount G2 at a prescribed amount Gt in the first invention.

The blast furnace installation pertaining to the third invention is a blast furnace installation in which, based on information from the carrier gas state detection means, the control means, upon the temperature Tg of the carrier gas being equal to or less than the upper limit value Tu, controls the supply amount adjustment means for low-grade coal so as to increase the supply amount C2 of the pulverized coal of low-grade coal, and controls the supply amount adjustment means for high-grade coal so as to decrease the supply amount C1 of the pulverized coal of high-grade coal, and upon the temperature Tg of the carrier gas being greater than the upper limit value Tu, controls the inert gas feed amount adjustment means so as to increase the feed amount G2 of the inert gas, and controls the air feed amount adjustment means so as to decrease the feed amount G1 of the air in the second invention.

The blast furnace installation pertaining to the fourth invention is a blast furnace installation in which, based on information from the carrier gas state detection means, the control means, upon the temperature Tg of the carrier gas being equal to or greater than the lower limit value Td, controls the inert gas feed amount adjustment means so as to increase the feed amount G2 of the inert gas, and controls the air feed amount adjustment means so as to decrease the feed amount G1 of the air, and upon the temperature Tg of the carrier gas being less than the lower limit value Tu, determines whether or not the supply amount C2 of the pulverized coal of low-grade coal is the prescribed amount Ct, and upon the supply amount C2 of the pulverized coal of low-grade coal being the prescribed amount Ct, controls the air feed amount adjustment means and the inert gas feed amount adjustment means so as to bring the temperature Tg of the carrier gas in a range of the upper limit value Tu to the lower limit value Td, and upon the supply amount C2 of the pulverized coal of low-grade coal not being the prescribed amount Ct, controls the supply amount adjustment means for low-grade coal so as to increase the supply amount C2 of the pulverized coal of low-grade coal, and controls the supply amount adjustment means for high-grade coal so as to decrease the supply amount C1 of the pulverized coal of high-grade coal in the second or third invention.

The blast furnace installation pertaining to the fifth invention is a blast furnace installation in which the pyrolysis means pyrolyzes the low-grade coal at from 400 to 600° C. in any one of the first to fourth inventions.

The blast furnace installation pertaining to the sixth invention is a blast furnace installation in which the high-grade coal is anthracite coal or bituminous coal, and the low-grade coal is sub-bituminous coal or lignite in any one of the first to fifth inventions.

The blast furnace installation pertaining to a seventh invention is a blast furnace installation in which the inert gas is at least one among nitrogen gas, off-gas discharged from the blast furnace body, and combustion exhaust gas after the off-gas is combusted with air in any one of the first to sixth inventions.

### Advantageous Effects of Invention

By the blast furnace installation pertaining to the present invention, pulverized coal of inexpensive low-grade coal can be safely used as blowing coal (PCI coal) and the production cost of pig iron can be reduced due to the fact that blowing coal (PCI coal) into the tuyere of the blast furnace body can be switched from pulverized coal of high-grade coal to pulverized coal of low-grade coal even while the blast furnace body is operating.

### BRIEF DESCRIPTION OF DRAWINGS

FIG. 1 is a schematic configuration diagram of essential parts on a pulverized coal supply means side of a first embodiment of the blast furnace installation pertaining to the present invention.

FIG. 2 is a schematic configuration diagram of essential parts on the blast furnace body side of the first embodiment of the blast furnace installation pertaining to the present invention.

FIG. 3 is a control block diagram of essential parts of the first embodiment of the blast furnace installation pertaining to the present invention.

FIG. 4 is a control flow diagram of essential parts of the first embodiment of the blast furnace installation pertaining to the present invention.

FIG. 5 is a schematic configuration diagram of essential parts on the blast furnace body side of a second embodiment of the blast furnace installation pertaining to the present invention.

FIG. 6 is a control block diagram of essential parts of the second embodiment of the blast furnace installation pertaining to the present invention.

### DESCRIPTION OF EMBODIMENTS

Embodiments of the blast furnace installation pertaining to the present invention will be described based on the drawings, but the present invention is not limited only to the following embodiments described based on the drawings.

### First Embodiment

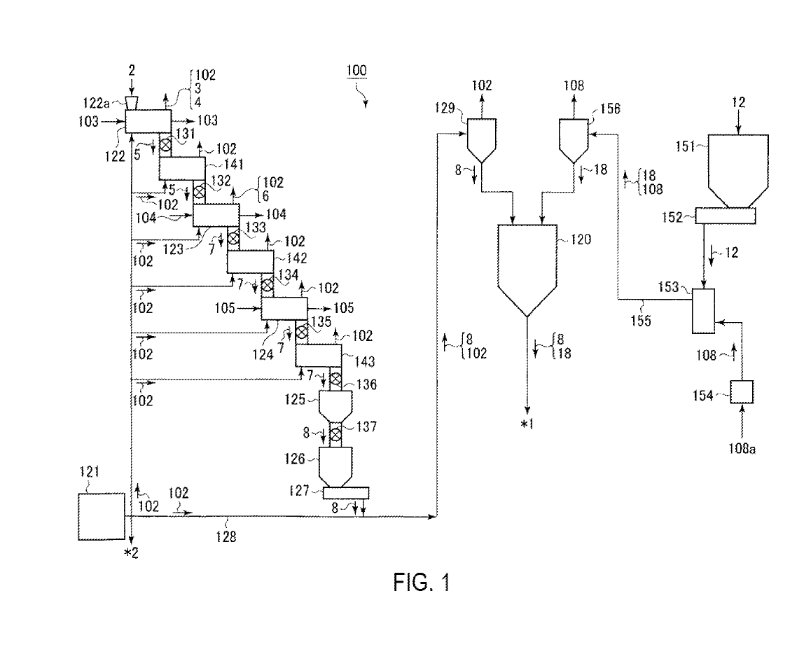

A first embodiment of the blast furnace installation pertaining to the present invention will be described based on FIGS. 1 to 4.

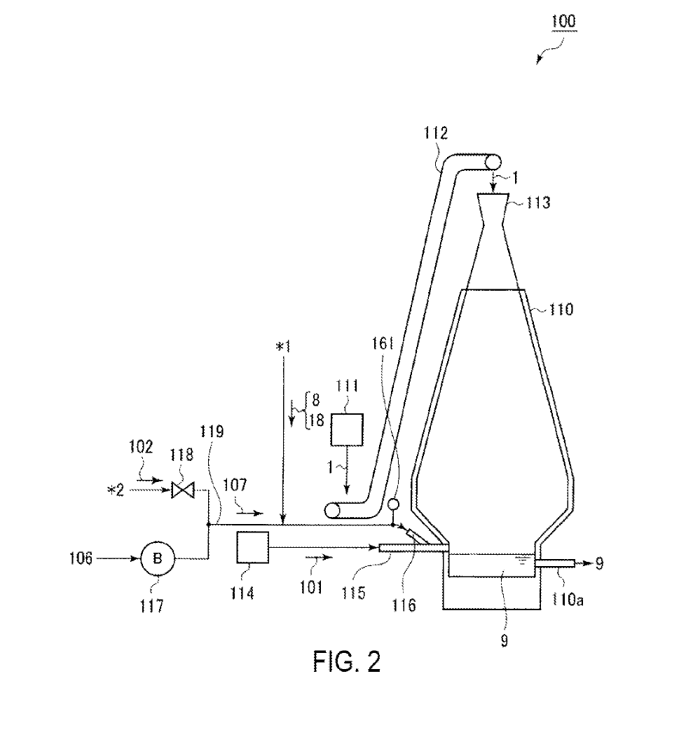

As illustrated in FIG. 2, a starting material dispensing device 111 for dispensing a starting material 1 such as iron ore, limestone or coal is connected on the upstream side in the conveyance direction of a charging conveyor 112 which conveys the starting material 1. On the downstream side in the conveyance direction of the charging conveyor 112, a throat hopper 113 of the top of a blast furnace body 110 is connected. A hot air feeding device 114 which feeds hot air 101 (from 1000° C. to 1300° C.) is connected to a blow pipe 115 provided on a tuyere of the blast furnace body 110.

In this embodiment, a starting material charging means is constituted by the starting material dispensing device 111, the charging conveyor 112, the throat hopper 113 and the like; and a hot air blowing means is constituted by the hot air feeding device 114, the blow pipe 115 and the like.

The distal side of an injection lance 116 is inserted and connected part way along the blow pipe 115. To the proximal side of the injection lance 116, a blast opening of an air blower 117, which serves as both an air feeding means for feeding air 106 and an air feed amount adjustment means, is connected via a supply line 119. Between the blast opening of the air blower 117 and the proximal side of the injection lance 116 along the supply line 119, an nitrogen gas supply source 121 (refer to FIG. 1), which is an inert gas feeding means for feeding nitrogen gas 102 which is an inert gas, is connected via a flow rate adjustment valve 118 which is an inert gas feed amount adjustment means.

On the other hand, as illustrated in FIG. 1, a storage tank 151 which stores high-grade coal 12 such as anthracite coal or bituminous coal therein is disposed near the blast furnace body 110. To the lower portion of the storage tank 151 is connected the proximal side of a feeder 152 which dispenses the high-grade coal 12 stored in the storage tank 151. The distal side of the feeder 152 is connected to the receiving port of a roller mill 153 which pulverizes the high-grade coal 12 (diameter equal to or less than 100 μm).

The outlet port of the roller mill 153 is connected to the receiving port of a cyclone separator 156 via a conveyor line 155. To the roller mill 153 is connected to a burner 154 which feeds combustion gas 108 obtained by burning natural gas 108a or the like, such that the roller mill 153 can pulverize the high-grade coal 12 while drying the high-grade coal 12 by heating (approximately 250° C.) by the combustion gas fed from the burner 154, and pneumatically convey the pulverized coal 18 via the conveyor line 155 to the cyclone separator 156.

Furthermore, a steam-tube-dryer-type drying device 122, which evaporates moisture 3 in low-grade coal 2 such as sub-bituminous coal or lignite, is disposed near the blast furnace body 110, and, by means of the nitrogen gas 102 from the nitrogen gas supply source 121 being fed to the interior and steam 103 which is a heating medium being fed to the interior of a coil heating pipe disposed in the center portion, this drying device 122 is configured to be able to heat (from 100 to 200° C.) the low-grade coal 2 supplied from the hopper 122a while maintaining the interior in a low-oxygen atmosphere (approximately several percent) to remove moisture 3 and volatile components 4 that are volatilized at a relatively low temperature from the low-grade coal 2 to produce dried coal 5, and at the same time, to discharge this moisture 3 and these volatile components 4 together with the nitrogen gas 102 to the exterior.

The discharge port for the dried coal 5 of the drying device 122 is connected via a rotary valve 131 to the upstream side in the conveyance direction of a conveyor 141 having a shield hood that covers the periphery. Nitrogen gas 102 from the nitrogen gas supply source 121 is fed inside the shield hood of the conveyor 141, to result in a nitrogen gas atmosphere inside the shield hood of the conveyor 141.

The downstream side in the conveyance direction of the conveyor 141 is connected via a rotary valve 132 to the receiving port for the dried coal 5 of a rotary kiln-type pyrolysis device 123 which pyrolyzes the dried coal 5, and, by means of the nitrogen gas 102 from the nitrogen gas supply source 121 being fed to the interior and combustion gas 104 which is a heating medium being fed to an external jacket supported in a fixed manner, this pyrolysis device 123 is configured to be able to heat (from 400 to 600° C.) the dried coal 5 while maintaining the interior in a nitrogen gas atmosphere to remove volatile components 6 that are volatilized at a relatively high temperature from the dried coal 5 to produce pyrolyzed coal 7, and at the same time, to discharge these volatile components 6 together with the nitrogen gas 102 to the exterior.

The discharge port for the pyrolyzed coal 7 of the pyrolysis device 123 is connected via a rotary valve 133 to the upstream side in the conveyance direction of a conveyor 142 having a shield hood that covers the periphery. Nitrogen gas 102 from the nitrogen gas supply source 121 is fed inside the shield hood of the conveyor 142, to result in a nitrogen gas atmosphere inside the shield hood of the conveyor 142.

The downstream side in the conveyance direction of the conveyor 142 is connected via a rotary valve 134 to the receiving port for the pyrolyzed coal 7 of a steam-tube-dryer-type cooling device 124 which cools the pyrolyzed coal 7, and, by means of the nitrogen gas 102 from the nitrogen gas supply source 121 being fed to the interior and cooling water 105 which is a cooling medium being fed to the interior of a coil cooling pipe disposed in the center portion, this cooling device 124 is configured to be able to cool (equal to or less than 200° C.) the pyrolyzed coal 7 while maintaining the interior in a nitrogen gas atmosphere.

The discharge port for the pyrolyzed coal 7 of the cooling device 124 is connected via a rotary valve 135 to the upstream side in the conveyance direction of a conveyor 143 having a shield hood that covers the periphery. Nitrogen gas 102 from the nitrogen gas supply source 121 is fed inside the shield hood of the conveyor 143, to result in a nitrogen gas atmosphere inside the shield hood of the conveyor 143.

The downstream side in the conveyance direction of the conveyor 143 is connected via a rotary valve 136 to the receiving port for pyrolyzed coal 7 of a mill-type pulverization device 125 which pulverizes the pyrolyzed coal 7, and the pulverization device 125 is configured to be able to pulverize the pyrolyzed coal 7 while maintaining the interior in a nitrogen gas atmosphere by nitrogen gas fed together with the pyrolyzed coal 7, to provide pulverized coal 8 (diameter equal to or less than 100 μm).

The lower portion of the pulverization device 125 is connected via a rotary valve 137 to the upper portion of a storage tank 126 which stores the pulverized coal 8, and this storage tank 126 is configured to be able to maintain the interior in a nitrogen gas atmosphere. To the lower portion of the storage tank 126 is connected the proximal side of a feeder 127 which dispenses the pulverized coal 8 stored in the storage tank 126. The distal side of the feeder 127 is connected part way along the conveyor line 128 extending from the nitrogen gas supply source 121. The conveyor line 128 is connected to the receiving port of a cyclone separator 129.

The lower portions of the cyclone separators 129, 156 are connected above a supply tank 120 into which the pulverized coals 8, 18 are put, and the supply tank 120 is configured to be able to maintain the interior in a nitrogen gas atmosphere, and to supply the pulverized coals 2, 18 by dropping from the interior.

As illustrated in FIGS. 1 and 2, the lower portion of the supply tank 120 is connected between the air blower 117 and the flow rate adjustment valve 118, and the injection lance 116 along the supply line 119, and, by means of a carrier gas 107 obtained by joining the air 106 from the air blower and the nitrogen gas 102 from the nitrogen gas supply source 121, the supply line 119 is configured to be able to pneumatically convey the pulverized coals 8, 18 supplied by being dropped from the interior of the supply tank 120 from the injection lance 116 to the blow pipe 115, to supply the pulverized coals 8, 18 to the tuyere.

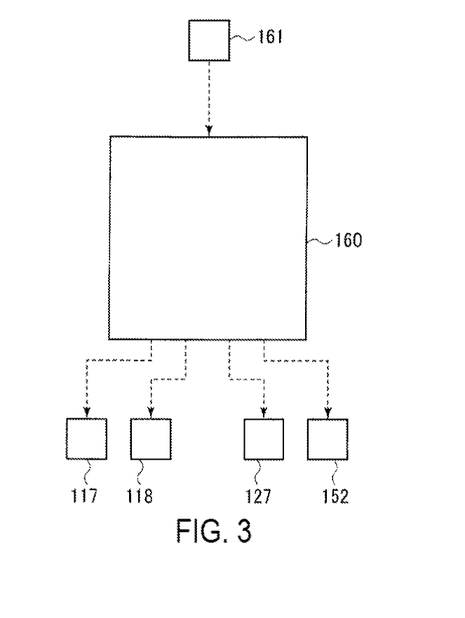

As illustrated in FIG. 2, near the proximal side of the injection lance 116, that is, near the tuyere, a temperature sensor 161, which is a carrier gas state detection means for detecting the temperature inside the injection lance 116, is provided. As illustrated in FIG. 3, the temperature sensor 161 is electrically connected to the input part of a control unit 160 which is a control means. The respective output parts of the control unit 160 are electrically connected to the air blower 117, the flow rate adjustment valve 118, and the feeders 127, 152, and, on the basis of information from the temperature sensor 161 or the like, the control unit 160 is configured to be able to control each of the blast volume of the air blower 117, the openness of the flow rate adjustment valve 118, and the supply amounts of the pulverized coals 8, 18 by the feeders 127, 152 (details will be described below).

In this embodiment, a moisture removal means for low-grade coal is constituted by the nitrogen gas supply source 121, the drying device 122, the rotary valve 131 and the like; a pyrolysis means is constituted by the nitrogen gas supply source 121, the pyrolysis device 123, the rotary valves 132, 133, the conveyor 141 and the like; a cooling means is constituted by the nitrogen gas supply source 121, the cooling device 124, the rotary valves 134, 135, the conveyor 142 and the like; a pulverization means for low-grade coal is constituted by the nitrogen gas supply source 121, the pulverization device 125, the rotary valve 136, the conveyor 143 and the like; a supply amount adjustment means for low-grade coal is constituted by the storage tank 126, the feeder 127, the rotary valve 136 and the like; a conveying means for low-grade coal is constituted by the nitrogen gas supply source 121, the conveyor line 128, the cyclone separator 129 and the like; a supply amount adjustment means for high-grade coal is constituted by the storage tank 151, the feeder 152 and the like; a moisture removal means for high-grade coal, a pulverization means for high-grade coal and a conveying means for high-grade coal are together constituted by the roller mill 153, the burner 154, the conveyor line 155, the cyclone separator 156 and the like; and a pulverized coal pneumatic supply means is constituted by the blow pipe 115, the injection lance 116, the air blower 117, the flow rate adjustment valve 118, the supply line 119, the nitrogen gas supply source 121 and the like. Furthermore, in FIG. 1, 110a is a taphole for drawing out melted pig iron (molten iron).

Now, the operation of the blast furnace installation 100 pertaining to this embodiment will be described.

When the starting material 1 is dispensed from the starting material dispensing device 111, the starting material 1 is supplied into the throat hopper 113 by the charging conveyor 112, and charged into the blast furnace body 110.

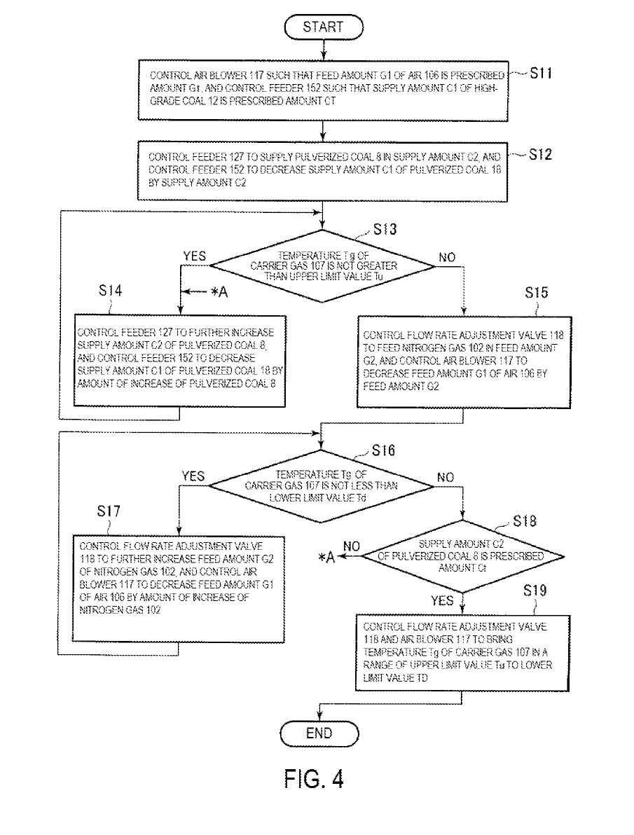

Additionally, when the control unit 160 is operated, the control unit 160 operates and controls the air blower 117 such that feed amount G1 of air 106 from the air blower 117 is a prescribed amount Gt, and operates and controls the supply rate of the feeder 152 such that supply amount C1 of high-grade coal 12 from inside the storage tank 151 to the roller mill 153 is a prescribed amount Ct (S11 in FIG. 4).

The high-grade coal 12 supplied from the feeder 152 is pulverized in the roller mill 153 while being dried by heating by combustion gas 108 (approximately 250° C.) from the burner 154, to result in pulverized coal 18 (diameter equal to or less than 100 μm), which is pneumatically conveyed to the cyclone separator 156 via the conveyor line 155. The pulverized coal 18 pneumatically conveyed to the cyclone separator 156 is separated from the combustion gas 108 and put into the supply tank 120.

The pulverized coal 18 that has been put into the supply tank 120 is supplied by being dropped a fixed amount at a time, and then pneumatically conveyed to the injection lance 116 via the supply line 119 by carrier gas 107 constituted by the air 106 from the air blower 117, and then supplied to the interior of the blow pipe 115 together with the carrier gas 107, and supplied into the hot air 101 from the hot air feeding device 114, thereby being burned.

The pulverized coal 18 burned in the interior of the blow pipe 115 becomes a flame and forms a raceway from the tuyere to the interior of the blast furnace body 110, and burns the coal and the like in the starting material 1 inside the blast furnace body 110. As a result, the iron ore in the starting material 1 is reduced to result in pig iron (molten iron) 9, which is drawn out from the taphole 110a.

On the other hand, when the nitrogen gas 102 from the nitrogen gas supply source 121 is fed and the low-grade coal 2 is supplied to the interior of the drying device 122 from the hopper 122a of the drying device 122, this low-grade coal 2 is heated (at from 100 to 200° C.) via the heating pipe by the steam 103 in a low-oxygen atmosphere (approximately several percent), and the moisture 3 and the volatile components 4 evaporate and are discharged outside the system together with the nitrogen gas 102, and the low-grade coal 2 is thereby dried to provide dried coal 5.

Furthermore, the nitrogen gas 102 that contains the volatile components 4 is utilized as the combustion gas 104 by means of combustion treatment in a combustion furnace (not illustrated), and then undergoes cleaning treatment.

The dried coal 5 is supplied to the conveyor 141 via the rotary valve 131 and conveyed in a nitrogen gas atmosphere, and is then supplied to the interior of the pyrolysis device 123 via the rotary valve 132, and then heated (at from 400 to 600° C.) via the heating pipe by the combustion gas 104 in a nitrogen gas atmosphere, and the volatile components 6 evaporate and are discharged outside the system together with the nitrogen gas 102, and the dried coal 5 is thereby pyrolyzed to provide pyrolyzed coal 7 which is highly reactive with oxygen.

Furthermore, the nitrogen gas 102 that contains the volatile components 6 is utilized as the combustion gas 104 by means of combustion treatment in a combustion furnace (not illustrated), and then undergoes cleaning treatment.

The pyrolyzed coal 7 is supplied to the conveyor 142 via the rotary valve 133 and conveyed in a nitrogen gas atmosphere, and is then supplied to the interior of the cooling device 124 via the rotary valve 134, and then cooled (at equal to or less than 200° C.) via the cooling pipe by the cooling water 105 in a nitrogen gas atmosphere, after which it is supplied to the conveyor 143 via the rotary valve 135 and conveyed in a nitrogen gas atmosphere, and then supplied to the interior of the pulverization device 125 via the rotary valve 136, and pulverized (diameter equal to or less than 100 μm) in a nitrogen gas atmosphere, thereby providing pulverized coal 8.

The pulverized coal 8 is supplied to the interior of the storage tank 126 via the rotary valve 137, and temporarily held in a nitrogen gas atmosphere.

In this manner, the blast furnace body 110 is operated while the pulverized coal 18 constituted by the high-grade coal 12 is blown into the blast furnace body 110, and when a prescribed time has elapsed, the control unit 160 operates and controls the supply rate of the feeder 127 such that the pulverized coal 8 is supplied from inside the storage tank 126 in supply amount C2, and operates and controls the supply rate of the feeder 152 so as to decrease supply amount C1 of the pulverized coal 18 from inside the storage tank 151 by the supply amount C2 of the pulverized coal 8 (C1=Ct−C2) (S12 in FIG. 4).

The pulverized coal 8 supplied in supply amount C2 from the feeder 127 is pneumatically conveyed to the cyclone separator 129 via the conveyor line 128 by nitrogen gas 102 from the nitrogen gas supply source 121, and after the nitrogen gas 102 is separated, is put into the supply tank 120.

As a result, a mixture of the pulverized coal 18 in supply amount C1 constituted by the high-grade coal 12 and the pulverized coal 8 in supply amount C2 constituted by the low-grade coal 2 is put into the supply tank 120 in the prescribed amount Ct (=C1+C2).

The pulverized coals 8, 18 that have been mixed in the supply tank 120, as previously described, are supplied by being dropped a fixed amount at a time, and then pneumatically conveyed to the injection lance 116 via the supply line 119 by means of the carrier gas 107 constituted by the air 106 from the air blower 117.

At this time, because the pulverized coal 8 constituted by the low-grade coal 2 has been increased in reactivity by being pyrolyzed and because the carrier gas 107 contains oxygen (approximately 21 vol %), a portion of the pulverized coal 8 reacts with oxygen and burns during pneumatic conveyance. For this reason, the carrier gas 107 and the pulverized coals 8, 18 have their temperatures increased by self-heating.

Then, on the basis of information from the temperature sensor 161, the control unit 160 determines whether or not temperature Tg of the carrier gas 107 is equal to or less than an upper limit value Tu (S13 in FIG. 4).

If the temperature Tg of the carrier gas 107 is equal to or less than the upper limit value Tu (Tg≦Tu), the control unit 160 operates and controls the supply rate of the feeder 127 so as to further increase the supply amount C2 of the pulverized coal 8 from inside the storage tank 126, and operates and controls the supply rate of the feeder 152 so as to decrease the supply amount C1 of the pulverized coal 18 from inside the storage tank 151 by the amount of increase of the pulverized coal 8 (C1=Ct−C2) (S14 in FIG. 4).

On the other hand, if the temperature Tg of the carrier gas 107 is greater than the upper limit value Tu (Tg>Tu), the control unit 160 operates and controls the openness of the flow rate adjustment valve 118 so as to feed the nitrogen gas 102 in feed amount G2 from the nitrogen gas supply source 121, and operates and controls the air blower 117 so as to decrease feed amount G1 of the air 106 from the air blower 117 by the feed amount G2 of the nitrogen gas 102 (G1=Gt−G2) (S15 in FIG. 4).

As a result, the oxygen concentration of the carrier gas 107 which pneumatically conveys the pulverized coals 8, 18 decreases, and the amount of the pulverized coal 8 that reacts with oxygen and burns while being pneumatically conveyed decreases, and therefore, a temperature rise of the carrier gas 107 and the pulverized coals 8, 18 is suppressed.

Next, on the basis of information from the temperature sensor 161, the control unit 160 determines whether or not the temperature Tg of the carrier gas 107 is equal to or greater than a lower limit value Td (S16 in FIG. 4).

If the temperature Tg of the carrier gas 107 is equal to or greater than the lower limit value Td (Tg≧Td), the control unit 160 operates and controls the openness of the flow rate adjustment valve 118 so as to increase the feed amount G2 of the nitrogen gas 102 from the nitrogen gas supply source 121, and operates and controls the air blower 117 so as to decrease the feed amount G1 of the air 106 from the air blower 117 by the amount of the increase of the nitrogen gas 102 (G1=Gt−G2) (S17 in FIG. 4).

On the other hand, if the temperature Tg of the carrier gas 107 is less than the lower limit value Td (Tg<Td), the control unit 160 determines whether or not the supply amount C2 of the pulverized coal 8 from inside the storage tank 126 is the prescribed amount Ct (C2=Ct), that is, whether or not the supply amount C1 of the pulverized coal 18 from inside the storage tank 151 is zero (C1=0) (S18 in FIG. 4).

If the supply amount C2 is the prescribed amount Ct (C2=Ct), that is, the supply amount C1 is zero (C1=0), in other words, if the blowing coal (PCI coal) to the tuyere of the blast furnace body 110 has been switched from the pulverized coal 18 of the high-grade coal 12 to the pulverized coal 8 of the low-grade coal 2, the control unit 160, on the basis of information from the temperature sensor 161, operates and controls the flow rate adjustment valve 118 and the air blower 117 so as to bring the temperature Tg of the carrier gas 107 in a range of the upper limit value Tu to the lower limit value Td, thereby adjusting the oxygen concentration of the carrier gas 107 while feeding the carrier gas 107 in the prescribed amount Gt (S19 in FIG. 4).

On the other hand, if the supply amount C2 is not the prescribed amount Ct (C2≠Ct), that is, the supply amount C1 is not zero (C1≠0), the control unit 160 returns to step S14 and repeats the steps described above.

In short, a conventional blast furnace installation uses only pulverized coal 18 of high-grade coal 12, such as high-quality, expensive anthracite coal or bituminous coal, as blowing coal (pulverized coal injection: PCI coal). In the blast furnace installation 100 pertaining to this embodiment, however, low-grade coal 2 such as sub-bituminous coal or lignite is turned into pyrolyzed coal 7 which is highly reactive with oxygen (reactivity with oxygen approximately 20 times that of low-grade coal 2) by being dried and pyrolyzed. Then, in a nitrogen gas atmosphere, pulverized coal 8 which has been cooled and pulverized is conveyed by a nitrogen gas stream and supplied into the supply tank 120 having a nitrogen gas atmosphere. While maintaining the total amount of the supply amount C1 of the pulverized coal 18 of high-grade coal 12 and the supply amount C2 of the pulverized coal 8 of low-grade coal 2 at the prescribed amount Ct, the pulverized coal 8 is pneumatically conveyed by the carrier gas 107 from inside the supply tank 120 while gradually increasing the supply amount C2 of the pulverized coal 8 of low-grade coal 2, thereby allowing the pulverized coal 8 to be safely used as blowing coal (PCI coal) while gradually switching the pulverized coal 18 to the pulverized coal 8 obtained by imparting high combustion characteristics to inexpensive low-grade coal 2.

For this reason, in the blast furnace installation 100 pertaining to this embodiment, blowing coal (PCI coal) into the tuyere of the blast furnace body 110 can be switched from the pulverized coal 18 of high-grade coal 12 to the pulverized coal 8 of low-grade coal 2 while the blast furnace body 110 is operating and without causing abnormal combustion in the pulverized coal 8.

Therefore, by the blast furnace installation 100 pertaining to this embodiment, the production cost of pig iron 9 can be reduced due to the fact that pulverized coal 8 of inexpensive low-grade coal 2 can be safely used as blowing coal (PCI coal).

Additionally, the ignitability of the pulverized coals 8, 18 can be sped up and burn-out capability can be improved because the carrier gas 107 and the pulverized coals 8, 18 can be preheated by self-heating accompanying the reaction of the pulverized coal 8 with oxygen.

Furthermore, with improvement of ignitability (burn-out capability) of the blowing coal (PCI coal), the supply amount of blowing coal (PCI coal) may be reduced and the production cost of pig iron 9 can be further reduced. Conversely, with improvement of ignitability (burn-out capability) of the blowing coal (PCI coal), the supply amount of blowing coal (PCI coal) may be increased, and therefore the amount of coal (coke) to be supplied as the starting material 1 to the top of the blast furnace body 110 may be reduced and the production cost of pig iron 9 can be further reduced.

Furthermore, as the upper limit value Tu of the temperature Tg of the carrier gas 107, the pyrolysis temperature of the low-grade coal 2 (from 400 to 600° C.) is preferred, and, in particular, a temperature lower by about 100° C. than the pyrolysis temperature (from 300 to 500° C.) is more preferred. This is because if the upper limit value Tu is greater than the pyrolysis temperature, there is risk of thermolysis products such as tar being produced from the pulverized coal 8, and these thermolysis products adhering to the inner wall surface of the injection lance 116 and the like, and blocking the injection lance 116 and the like.

As the lower limit value Td of the temperature Tg of the carrier gas 107, 200° C. is preferred, and, in particular, a temperature lower by from about 50 to 100° C. than the upper limit value Tu (from 200 to 450° C.) is more preferred. This is because if the lower limit temperature Td is less than 200° C., there is risk that it will be difficult to sufficiently improve the ignitibility (burn-out capability) of the pulverized coal 8. Here, if the temperature is lower by from about 50 to 100° C. than the upper limit value Tu (from 200 to 450° C.), the control allowance of rising and lowering temperature can be within the required sufficient range, reducing waste in energy and time.

Furthermore, it is preferred that the control unit 160 adjust the supply amount C2 (increase amount) of the pulverized coal 8 and the feed amount G2 (increase amount) of the nitrogen gas 102, in order words, the supply amount C1 (decrease amount) of the pulverized coal 18 and the feed amount G1 (decrease amount) of the air 106 while controlling the feeders 127, 152, the flow rate adjustment valve 118 and the air blower 117 on the basis of information from the temperature sensor 161 such that a temperature rise (temperature rising rate) per unit time of the temperature Tg of the carrier gas 107 is within a prescribed range.

### Second Embodiment

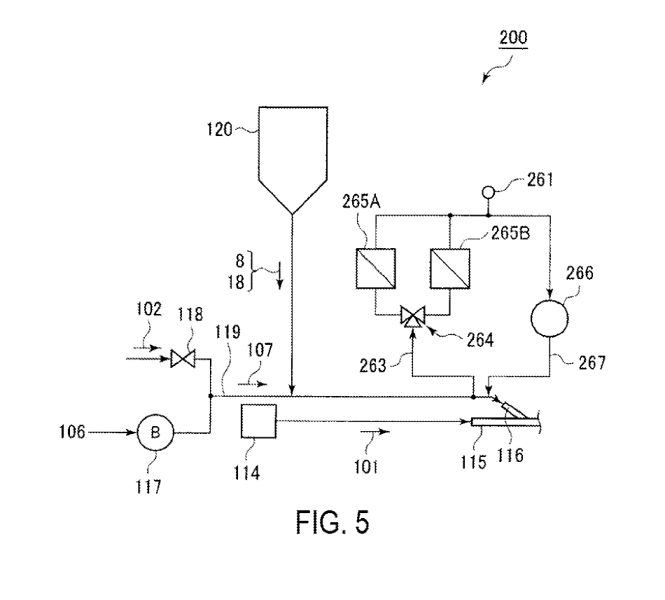

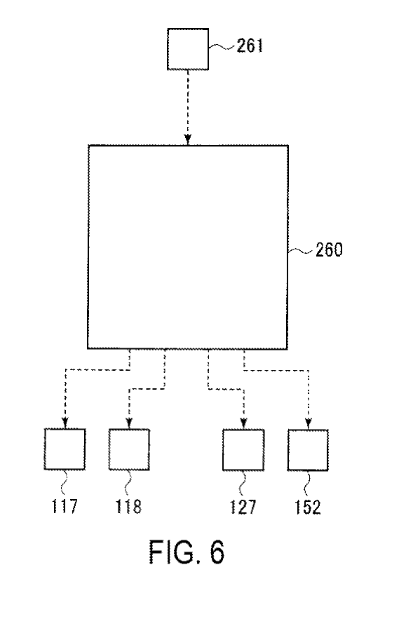

A second embodiment of the blast furnace installation pertaining to the present invention will be described based on FIGS. 5 and 6. Note that the same reference numerals as those used in the description of the embodiment above are used for the portions that are the same as in the embodiment above, and therefore, descriptions that are duplicates of those in the embodiment above are omitted.

As illustrated in FIG. 5, the proximal side of a fractionation line 263 is connected near the proximal end of the injection lance 116 between the injection lance 116 and the supply tank 120 along the supply line 119. The distal side of the fractionation line 263 is connected to one port of a three-way valve 264. The remaining two ports of the three-way valve 264 are respectively connected to filter devices 265A, 265B.

The outlet ports of the filter devices 265A, 265B are connected to the suction port of a suction pump 266. The outlet port of the suction pump 266 is connected via a return line 267 between the proximal side of the fractionation line 263 and the proximal side of the injection lance 116. A CO sensor 261 which detects the carbon monoxide concentration in the carrier gas 107 fractionated from the fractionation line 263 is provided between the outlet ports of the filter devices 265A, 265B and the suction port of the suction pump 266.

As illustrated in FIG. 6, the CO sensor 261 is electrically connected to the input part of the control unit 260 which is the control means. The respective output parts of the control unit 260 are electrically connected to the air blower 117, the flow rate adjustment valve 118, and the feeders 127, 152, and, on the basis of information from the CO sensor 261 or the like, the control unit 260 is configured to be able to control each of the blast volume of the air blower 117, the openness of the flow rate adjustment valve 118, and the supply amounts of the pulverized coals 8, 18 by the feeders 127, 152 (details will be described later).

Furthermore, in this embodiment, a carrier gas state detection means is constituted by the CO sensor 261, the fractionation line 263, the three-way valve 264, the filter devices 265A and 265B, the suction pump 266, the return line 267 and the like.

In the blast furnace installation 200 pertaining to this embodiment, similar to the embodiment described above, while the starting material 1 is charged into the blast furnace body 110, the three-way valve 264 is opened and closed such that only one of the filter devices 265A, 265B (for example, filter device 265A) is connected to the fractionation line 263 and the return line 267, and the suction pump 266 is operated and the control unit 260 is operated. Then, the control unit 260, similar to the embodiment described above, operates and controls the air blower 117 so as to feed the air 106 from the air blower 117 such that the feed amount G1 is the prescribed amount Gt, and operates and controls the supply rate of the feeder 152 so as to supply the high-grade coal 12 from inside the storage tank 151 to the roller mill 153 such that the supply amount C1 is the prescribed amount Ct.

The high-grade coal 12 supplied from the feeder 152, similar to the embodiment described above, becomes pulverized coal 18 which is pneumatically conveyed, separated from the combustion gas 108 via the cyclone separator 156, and put into the supply tank 120.

The pulverized coal 18 that has been put into the supply tank 120, similar to the embodiment described above, is supplied by being dropped a fixed amount at a time, and then pneumatically conveyed to the injection lance 116 via the supply line 119 by the carrier gas 107 constituted by the air 106 from the air blower 117, and then supplied to the interior of the blow pipe 115 together with the carrier gas 107, and supplied into the hot air 101 from the hot air feeding device 114, thereby being burned.

The pulverized coal 18 that has been burned in the interior of the blow pipe 115, similar to the embodiment described above, becomes a flame and forms a raceway from the tuyere to the interior of the blast furnace body 110, and burns the coal and the like in the starting material 1 inside the blast furnace body 110.

On the other hand, similar to the embodiment described above, the pulverized coal 8 is produced by drying, pyrolyzing, cooling and pulverizing the low-grade coal 2, and this pulverized coal 8 is stored temporarily in a nitrogen gas atmosphere in the storage tank 126.

Then, the blast furnace body 110 is operated while the pulverized coal 18 constituted by the high-grade coal 12 is blown into the blast furnace body 110, and when a prescribed time has elapsed, the control unit 260, similar to the embodiment described above, operates and controls the supply rate of the feeder 127 such that the pulverized coal 8 is supplied from inside the storage tank 126 in the supply amount C2, and operates and controls the supply rate of the feeder 152 so as to decrease the supply amount C1 of the pulverized coal 18 from inside the storage tank 151 by the supply amount C2 of the pulverized coal 8 (C1=Ct−C2).

The pulverized coal 8 supplied from the feeder 127 in the supply amount C2, similar to the embodiment described above, is pneumatically conveyed by the nitrogen gas 102, separated from the nitrogen gas 102 via the cyclone separator 129, and put into the supply tank 120.

As a result, similar to the embodiment described above, a mixture of the pulverized coal 18 in the supply amount C1 constituted by the high-grade coal 12 and the pulverized coal 8 in the supply amount C2 constituted by the low-grade coal 2 is put into the supply tank 120 in the prescribed amount Ct (=C1+C2).

The pulverized coals 8, 18 that have been mixed in the supply tank 120, similar to the embodiment described above, are supplied by being dropped a fixed amount at a time, and then pneumatically conveyed to the injection lance 116 via the supply line 119 by means of the carrier gas 107 constituted by the air 106 from the air blower 117.

At this time, similar to the embodiment described above, because the pulverized coal 8 constituted by the low-grade coal 2 has been increased in reactivity by being pyrolyzed and because the carrier gas 107 contains oxygen (approximately 21 vol %), a portion of the pulverized coal 8 reacts with oxygen and burns during pneumatic conveyance. For this reason, the carrier gas 107 and the pulverized coals 8, 18 have their temperatures increased by self-heating.

Here, the carrier gas 107 that has been pneumatically conveyed to near the proximal side of the injection lance 116 is partially fractionated into the fractionation line 263 from the supply line 119 by the suction pump 266 and passes through the three-way valve 264, and after the pulverized coals 8, 18 and the like are removed by the filter device 265A, the carbon monoxide concentration is detected by the CO sensor 261, and the carrier gas 107 is then returned from the return line 267 via the suction pump 266 to the supply line 119.

Then, the control unit 260 controls the blast volume of the air blower 117 and the openness of the flow rate adjustment valve 118 on the basis of information from the CO sensor 261. Specifically, the carbon monoxide concentration in the carrier gas 107 is a value substantially determined by the type of the pulverized coals 8, 18 (coal type), the supply amount of the pulverized coals 8, 18, the oxygen concentration in the carrier gas 107, and the temperature of the carrier gas 107.

For this reason, the temperature Tg of the carrier gas 107 can be determined by detecting the carbon monoxide concentration in the carrier gas 107 since the supply amount and type of the pulverized coals 8, 18 are predetermined and the oxygen concentration in the carrier gas 107 can be calculated.

As a result, the control unit 260 calculates the temperature Tg of the carrier gas 107 on the basis of information from the CO sensor 261, that is, the carbon monoxide concentration of sampled carrier gas 107, in other words, the carbon monoxide concentration in the carrier gas 107 near the tuyere, and, similar to the embodiment described above, controls the air blower 117, the flow rate adjustment valve 118 and the feeders 127, 152 on the basis of the upper limit value Tu and lower limit value Td of the temperature Tg of the carrier gas 107, the supply amount C2 of the pulverized coal 8, and the like.

Furthermore, since the filter device 265A gradually becomes clogged due to sampling of the carrier gas 107, sampling of the carrier gas 107 can be continuously performed by, after a prescribed time has elapsed, opening and closing the three-way valve 264 so as to connect only the filter device 265B to the fractionation line 263 and the return line 267, and replacing the filter device 265A with a new one.

In short, in the blast furnace installation 100 pertaining to the embodiment described above, the temperature of the carrier gas 107 is directly detected by the temperature sensor 161 provided near the proximal side of the injection lance 116, but in the blast furnace installation 200 pertaining to this embodiment, the temperature of the carrier gas 107 is determined by calculation by the control unit 260 by sampling the carrier gas 107 near the proximal side of the injection lance 116 into a sampling line and detecting its carbon monoxide concentration by the CO sensor 261.

For this reason, in the blast furnace installation 200 pertaining to this embodiment, the temperature of the carrier gas 107 can be detected without sticking the detecting part of a sensor or the like into the line through which the majority of the carrier gas 107 flows.

Therefore, by the blast furnace installation 200 pertaining to this embodiment, since the same effects as the previously described embodiment can naturally be obtained and adhesion and the like of the pulverized coals 8, 18 to the detecting part of the sensor can be prevented, more accurate control can be performed, and blockage and the like near the proximal side of the injection lance 116 can be suppressed beforehand.

### Other Embodiments

In the first and second embodiments described above, the case where the drying device 122 and the cooling device 124 have steam tube dryers employed therein has been described, but as another embodiment, it is also possible to employ, for example, a rotary kiln similar to the pyrolysis device 123 in the drying device and cooling device.

Furthermore, in the first and second embodiments described above, the case where nitrogen gas 102 is fed from the nitrogen gas supply source 121 has been described, but as another embodiment, for example, blast furnace off-gas (approximately 200° C.) discharged from the blast furnace body 110, or combustion exhaust gas (approximately 100° C.) of the blast furnace off-gas, which has been generated after the blast furnace off-gas is combusted together with air and has been used as a heat source of the hot air 101, may be used as an inert gas instead of the nitrogen gas 102. That is, the blast furnace body 110 or the hot air feeding device 114 or the like may also be used as an inert gas supply source.

Additionally, in the first and second embodiments described above, combustion gas 108 obtained by burning the natural gas 108a by the burner 154 is fed to the roller mill 153 to dry the high-grade coal 12 and is used as gas for pneumatically conveying the pulverized coal 18, but as another embodiment, the consumption amount of the natural gas 108a can be greatly decreased and costs can be further reduced if, for example, after the combustion gas 104 which has been used in heating for pyrolysis in the pyrolysis device 123 is subjected to heat recovery and moisture removal by a heat exchanger or the like, the combustion gas 104 is fed to the roller mill 153, that is, the combustion gas 104 is used instead of the combustion gas 108.

Furthermore, in the second embodiment described above, the temperature Tg of the carrier gas 107 is determined by detecting the carbon monoxide in the carrier gas 107 by the CO sensor 261, but as another embodiment, the temperature Tg of the carrier gas 107 can also be determined by employing, for example, a CO₂ sensor that detects the carbon dioxide concentration or an O₂ sensor that detects the oxygen concentration in the carrier gas 107, instead of the CO sensor 261.

Furthermore, in the case where the storage tank 151 which stores the high-grade coal 12 is extremely large and is equipped with a plurality of (for example, two) parallel feeders 152, roller mills 153, burners 154, cyclone separators 156 and the like, it is possible to omit the cyclone separator 129 and to reduce installation space by, for example, connecting the conveyor line 128 and the like such that at least one of the cyclone separators 156 can be used instead of the cyclone separator 129.

In this case, the following configurations, for example, are preferred.

(1) The gas outlet port of the cyclone separator 156 is connected to the conveyor line 128 via a recirculating line having a blower or the like, so that nitrogen gas 102 discharged from the cyclone separator 156 used instead of the cyclone separator 129 can be reused.

(2) For the cyclone separator 156 used instead of the cyclone separator 129 in above-described (1), to prevent mixing of oxygen gas in the conveyor line 128 when switching from the pulverized coal 18 of high-grade coal 12 to the pulverized coal 8 of low-grade coal 2, an O₂ sensor is provided in the recirculating line, and the pulverized coal 8 is supplied to the conveyor line 128 after the nitrogen gas 102 from the nitrogen gas supply source 121 is made to flow until the O₂ concentration in the gas flowing through the recirculating line reaches a value equal to or less than a prescribed value.

(3) For the cyclone separator 156 used instead of the cyclone separator 129 in above-described (1), in the case where the pulverized coal 18 of high-grade coal 12 and the pulverized coal 8 of low-grade coal 2 are supplied in parallel, an O₂ sensor, CO sensor, CO₂ sensor, temperature sensor or the like is provided in the recirculating line, and nitrogen gas 102 is made possible to be additionally supplied to the conveyor line 155 and the burner 154 which produces the combustion gas 108 which pneumatically conveys the pulverized coal 18 to the cyclone separator 156, and, based on information from the sensor, the oxygen concentration (temperature) in the cyclone separator 129, the conveyor line 128, or the like is made to be equal to or less than a prescribed value.

### INDUSTRIAL APPLICABILITY

The blast furnace installation pertaining to the present invention can be used extremely advantageously in the iron-making industry because it can reduce the production cost of pig iron.

### REFERENCE SIGNS LIST

1 Starting material
2 Low-grade coal
3 Moisture
4, 6 Volatile components
5 Dried coal
7 Pyrolyzed coal
8 Pulverized coal (low-grade coal)
9 Pig iron (molten iron)
12 High-grade coal
18 Pulverized coal (high-grade coal)
100 Blast furnace installation
101 Hot air
102 Nitrogen gas
103 Steam
104 Combustion gas
105 Cooling water
106 Air
107 Carrier gas
108 Combustion gas
108a Natural gas
110 Blast furnace body
110a Taphole
111 Starting material dispensing device
112 Charging conveyor
113 Throat hopper
114 Hot air feeding device
115 Blow pipe
116 Injection lance
117 Air blower
118 Flow rate adjustment valve
119 Supply line
120 Supply tank
121 Nitrogen gas supply source
122 Drying device
122a Hopper
123 Pyrolysis device
124 Cooling device
125 Pulverization device
126 Storage tank
127 Feeder
128 Conveyor line
129 Cyclone separator
131 to 137 Rotary valves
141 to 143 Conveyors
151 Storage tank
152 Feeder
153 Roller mill
154 Burner
155 Conveyor line
156 Cyclone separator
160 Control unit
161 Temperature sensor
200 Blast furnace installation
260 Control unit
261 CO sensor
263 Fractionation line
264 Three-way valve
265A, 265B Filter devices
266 Suction pump
267 Return line

1. A blast furnace installation comprising:
a blast furnace body;
starting material charging means for charging a starting material from a top into an interior of the blast furnace body;
hot air blowing means for blowing hot air into the blast furnace body from a tuyere; and
pulverized coal supply means for supplying pulverized coal into the blast furnace body through the tuyere; wherein
the pulverized coal supply means includes:
moisture removal means for high-grade coal for evaporating moisture in high-grade coal;
pulverization means for high-grade coal for pulverizing the high-grade coal, moisture in the high-grade coal having been removed by the moisture removal means for high-grade coal, to provide pulverized coal;
moisture removal means for low-grade coal for evaporating moisture in low-grade coal;
pyrolysis means for pyrolyzing the low-grade coal, moisture in the low-grade coal having been removed by the moisture removal means for low-grade coal;
cooling means for cooling the low-grade coal, the low-grade coal having been pyrolyzed by the pyrolysis means;
pulverization means for low-grade coal for pulverizing the low-grade coal, the low-grade coal having been cooled by the cooling means, to provide pulverized coal;
a supply tank having an interior maintained in an inert gas atmosphere and having the pulverized coal of high-grade coal and the pulverized coal of low-grade coal put therein, the pulverized coal of high-grade coal and the pulverized coal of low-grade coal being obtained through pulverization by the pulverization means for high-grade coal and the pulverization means for low-grade coal;
conveying means for high-grade coal for conveying the pulverized coal of high-grade coal into the supply tank, the pulverized coal of high-grade coal being obtained through pulverization by the pulverization means for high-grade coal;
supply amount adjustment means for high-grade coal for adjusting a supply amount C1 of the pulverized coal of high-grade coal to be conveyed into the supply tank;
conveying means for low-grade coal for pneumatically conveying the pulverized coal of low-grade coal into the supply tank by an inert gas, the pulverized coal of low-grade coal being obtained through pulverization by the pulverization means for low-grade coal;
supply amount adjustment means for low-grade coal for adjusting a supply amount C2 of the pulverized coal of low-grade coal to be conveyed into the supply tank;
pulverized coal pneumatic supply means for pneumatically conveying the pulverized coal in the supply tank by a carrier gas and supplying the pulverized coal to the tuyere; and
control means for controlling the supply amount adjustment means for low-grade coal and the supply amount adjustment means for high-grade coal so as to gradually increase the supply amount C2 while maintaining a total amount of the supply amount C1 and the supply amount C2 at a prescribed amount Ct.

2. The blast furnace installation according to claim 1, wherein
the pulverized coal supply means includes carrier gas state detection means for detecting at least one among temperature, oxygen concentration, carbon monoxide concentration, and carbon dioxide concentration of the carrier gas near the tuyere;
the pulverized coal pneumatic supply means includes:
air feeding means for feeding air;
air feed amount adjustment means for adjusting a feed amount G1 of air from the air feeding means;
inert gas feeding means for feeding inert gas;
inert gas feed amount adjustment means for adjusting a feed amount G2 of inert gas from the inert gas feeding means; and
a supply line for supplying, to the tuyere, the pulverized coal by pneumatic conveyance by the carrier gas obtained by joining the air from the air feeding means and the inert gas from the inert gas feeding means; and
the control means, based on information from the carrier gas state detection means, controls the air feed amount adjustment means and the inert gas feed amount adjustment means so as to bring temperature Tg of the carrier gas in a range of an upper limit value Tu to a lower limit value Td while maintaining a total amount of the feed amount G1 and the feed amount G2 at a prescribed amount Gt.

3. The blast furnace installation according to claim 2, wherein
based on information from the carrier gas state detection means,
the control means, upon the temperature Tg of the carrier gas being equal to or less than the upper limit value Tu, controls the supply amount adjustment means for low-grade coal so as to increase the supply amount C2 of the pulverized coal of low-grade coal, and controls the supply amount adjustment means for high-grade coal so as to decrease the supply amount C1 of the pulverized coal of high-grade coal; and
the control means, upon the temperature Tg of the carrier gas being greater than the upper limit value Tu, controls the inert gas feed amount adjustment means so as to increase the feed amount G2 of the inert gas, and controls the air feed amount adjustment means so as to decrease the feed amount G1 of the air.

4. The blast furnace installation according to claim 2, wherein
based on information from the carrier gas state detection means,
the control means, upon the temperature Tg of the carrier gas being equal to or greater than the lower limit value Td, controls the inert gas feed amount adjustment means so as to increase the feed amount G2 of the inert gas, and controls the air feed amount adjustment means so as to decrease the feed amount G1 of the air;
the control means, upon the temperature Tg of the carrier gas being less than the lower limit value Tu, determines whether or not the supply amount C2 of the pulverized coal of low-grade coal is the prescribed amount Ct;
the control means, upon the supply amount C2 of the pulverized coal of low-grade coal being the prescribed amount Ct, controls the air feed amount adjustment means and the inert gas feed amount adjustment means so as to bring the temperature Tg of the carrier gas in a range of the upper limit value Tu to the lower limit value Td; and
the control means, upon the supply amount C2 of the pulverized coal of low-grade coal not being the prescribed amount Ct, controls the supply amount adjustment means for low-grade coal so as to increase the supply amount C2 of the pulverized coal of low-grade coal, and controls the supply amount adjustment means for high-grade coal so as to decrease the supply amount C1 of the pulverized coal of high-grade coal.

5. The blast furnace installation according to claim 1, wherein
the pyrolysis means pyrolyzes the low-grade coal at from 400 to 600° C.

6. The blast furnace installation according to claim 1, wherein
the high-grade coal is anthracite coal or bituminous coal, and
the low-grade coal is sub-bituminous coal or lignite.

7. The blast furnace installation according to claim 1, wherein
the inert gas is at least one among nitrogen gas, off-gas discharged from the blast furnace body, and combustion exhaust gas after the off-gas is combusted with air.
